(19) United States
(12) Patent Application Publication
(10) Pub. No.: US 2019/0041233 A1
(43) Pub. Date: Feb. 7, 2019

(54) OPTIMIZED FLIGHT PLAN ENSURING AN AVAILABLE LANDING LOCATION WITHIN GLIDE RANGE

(71) Applicant: Garmin International, Inc., Olathe, KS (US)

(72) Inventor: Noel J. Duerksen, Spring Hill, KS (US)

(21) Appl. No.: 15/666,392

(22) Filed: Aug. 1, 2017

(51) Int. Cl. G01C 23/00; G08G 5/00; B64D 43/00

(52) U.S. Cl. CPC G01C 23/00; G08G 5/0091; B64D 43/00; G08G 5/0086; G08G 5/0034

(57) ABSTRACT

Techniques are disclosed for determining an optimized flight path for an aircraft between a starting location and a destination location. The optimized flight path is calculated using flight information such as a starting location and a destination location, identified available emergency landing locations between the starting location and the destination location, and a calculated glide range perimeter of the aircraft. A series of iterative processing steps may be performed using this information to calculate an optimized flight path enabling the aircraft to always have an available landing location within the aircraft's gliding range. The optimized flight path may further utilize information from various data sources, including aircraft data, site data, weather data, and geography data, to more accurately calculate the gliding range and thus, the optimal flight path.

### TECHNICAL FIELD

The present disclosure relates generally to the calculation of optimized flight plans and, more particularly, to the calculation of optimized flight plans that ensure that an available landing location is always within an aircraft's glide range.

### BACKGROUND

In certain situations, a pilot may desire to plan a flight path that keeps his or her aircraft within gliding distance of a suitable landing location, such as a runway. This, unfortunately, can be a tedious task as it requires the pilot to calculate the aircraft's glide range along the entire flight path. Not only is this task tedious, but glide range can be difficult for the pilot to accurately compute along the flight path due to changes in terrain, weather, and altitude. Thus, pilots in these situations may be unable to calculate an ideal flight path and instead resort to circuitous paths or fly at higher than desired altitudes.

### SUMMARY

Embodiments of the present technology relate generally to the calculation of an optimized aircraft flight path. In particular, the optimized flight path enables an aircraft to always remain within gliding range of an available landing location throughout the entire duration of the flight path. In various embodiments, the optimized flight path may be calculated using any suitable combination of stored, retrieved, and/or user-entered parameters such as the starting and destination locations, flight information, aircraft information, weather information, geographic information, a maximum aircraft altitude during the flight path, etc.

The aforementioned information may be utilized to divide an initial, unoptimized flight path into multiple segments having a distance “D.” The optimized flight path may then be calculated by iteratively advancing the aircraft towards the destination location to multiple advancement positions by this distance D, calculating a glide range perimeter at each of these locations, and determining whether a suitable landing location is within the calculated glide range perimeter. If a suitable landing location is not within the calculated glide range perimeter, then a cross track distance may be calculated towards the closest landing location such that the initial flight path is shifted towards the suitable landing location by an amount that brings the suitable landing location within the calculated glide range perimeter. This process may be repeated for each flight path segment to calculate an optimized flight path. The resulting optimized flight path thus ensures that the aircraft is always within glide range of a suitable landing location while minimizing the overall flight path length.

This summary is provided to introduce a selection of concepts in a simplified form that are further described below in the detailed description. This summary does not necessarily identify key features or essential features of the claimed subject matter, nor does it limit the scope of the claimed subject matter. Other aspects and advantages of the present technology will be apparent from the following detailed description of the embodiments and the accompanying drawing figures.

### DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1A is a schematic representation illustrating a calculated initial straight-line flight path 14 used to determine an optimized flight path in accordance with embodiments of the technology;

FIG. 1B is a schematic representation illustrating a calculated optimized aircraft flight path 22 in accordance with embodiments of the technology;

FIG. 2 is a block diagram illustrating an example aircraft flight path optimization system 200 in accordance with embodiments of the technology;

FIG. 3 is a flowchart 300 for determining an optimized aircraft flight path in accordance with embodiments of the technology;

FIGS. 4A-4K illustrate various iterative steps for calculating an optimized aircraft flight path in accordance with embodiments of the technology; and

FIGS. 5-8 illustrate example screenshots of a software application that may be used in accordance with various embodiments of the technology.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

In embodiments, an optimized flight path is calculated between a starting location (e.g., a departure airport) and a destination location (e.g., a destination airport) such that the aircraft can safely glide to a landing location at any point during the flight in the event of engine failure or other type of emergency landing situation. An “available landing location” in this context may represent any location in which the aircraft can suitably land in the event of a necessary emergency landing, including the starting location and the destination location. For example, available landing locations may include runways, shorelines, etc. To accomplish this, various embodiments of the technology include calculating the optimized flight path via a series of iterative steps using a series of intermediate flight path segments and the locations of available landing locations, and the aircraft's glide range at each of the intermediate flight path segments, as further discussed below.

The glide range of an aircraft is related to the aircraft's glide ratio, which defines a ratio between forward movement of an aircraft and the downward movement without engine power. For example, a glide ratio of 10 indicates that for every 10 feet of forward movement the aircraft will lose 1 foot of altitude. Different models of aircraft have different specified glide ratios, which are typically specified for certain fixed conditions such as a particular aircraft speed, ambient temperature, humidity, altitude, etc. However, this specified glide ratio, and thus the aircraft's glide perimeter, may be further impacted by extraneous factors such as wind direction and speed at various altitudes, for example, as further discussed below. Thus, an aircraft has a glide range perimeter that is related to the aircraft's current altitude multiplied by its glide ratio, taking into consideration other extraneous factors. This glide range perimeter defines a total area around the aircraft in which the aircraft can glide without engine propulsion, which increases with the aircraft's altitude.

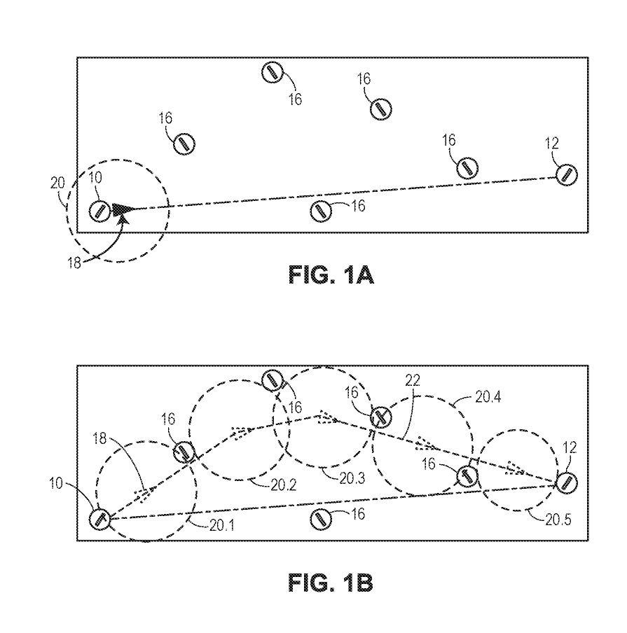

FIG. 1A is a schematic representation illustrating a calculated initial straight-line flight path 14 used to determine an optimized flight path in accordance with embodiments of the technology. As shown in FIG. 1A, an initial straight-line flight path 14 is shown between a starting location 10 and a destination location 12. The starting location 10 and the destination location 12 may be determined, for example, using input provided by a user such as an airport identifier or other location information for the starting location 10 and the destination location 12, a user selecting starting location 10 and the destination location 12 from a displayed map, menu, list, etc. Additionally or alternatively, embodiments include the starting location 10 being determined automatically using the current geographic location of the aircraft (i.e., assuming that the computing device is located in or near the aircraft). In any event, once the starting location 10 and destination location 12 have been determined, the initial straight-line flight path 14 may be calculated between the starting location 10 and the destination location 12. The initial straight-line flight path 14 thus represents the shortest distance between the starting location 10 and the destination location 12.

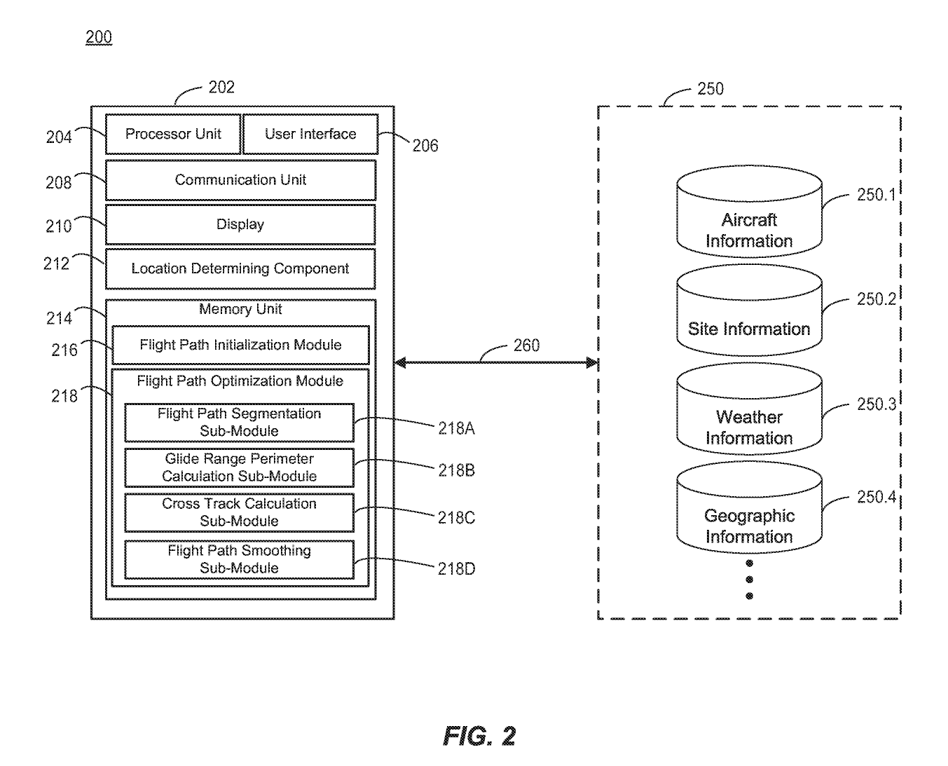

FIG. 1A also illustrates several available landing locations 16 that are located near the initial straight-line flight path 14, which may be used to develop the optimal flight path for an aircraft traveling from starting location 10 to destination location 12. As further discussed below, these available landing locations 16 may be identified in various manners, such as based upon their proximity to the initial straight-line flight path 14, the starting location 10, and/or the destination location 12. FIG. 1A also illustrates an aircraft 18 and its respective calculated glide range perimeter 20, which is centered at the aircraft 18. As shown in FIG. 1A, the glide range perimeter 20 may be characterized as a glide range ring with a radius representing the maximum distance the aircraft 18 can glide, or in a three-dimensional representation, as an inverted cone, in which the radius represents the maximum distance the aircraft can glide at its best glide speed depending on its current altitude and other factors (e.g., weather). In embodiments, various algorithms may be implemented to calculate the glide range perimeter 20, which are further discussed below with reference to FIG. 2.

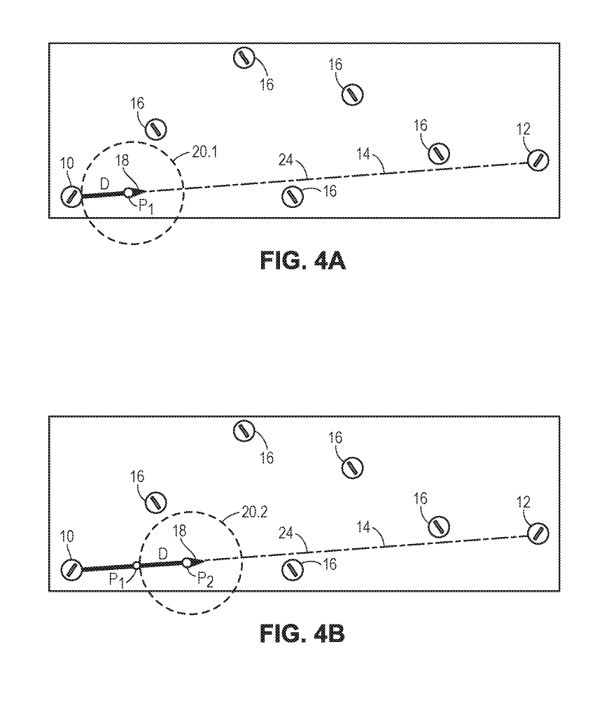

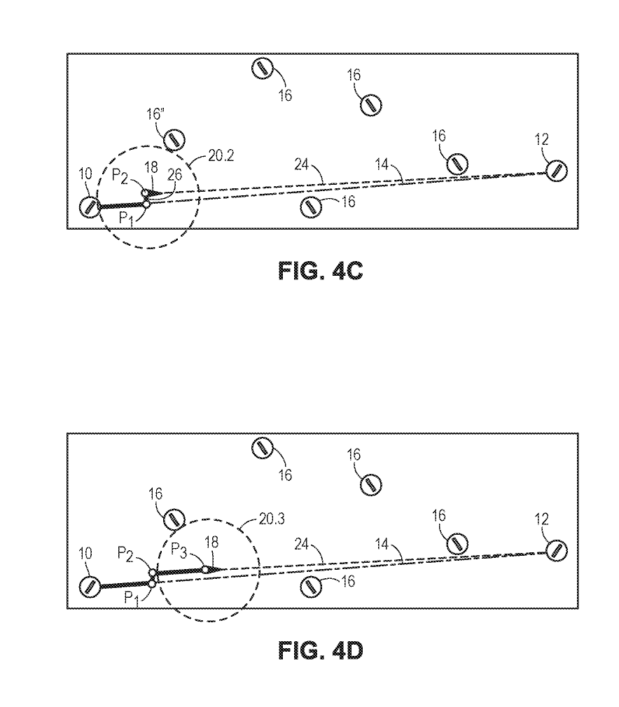

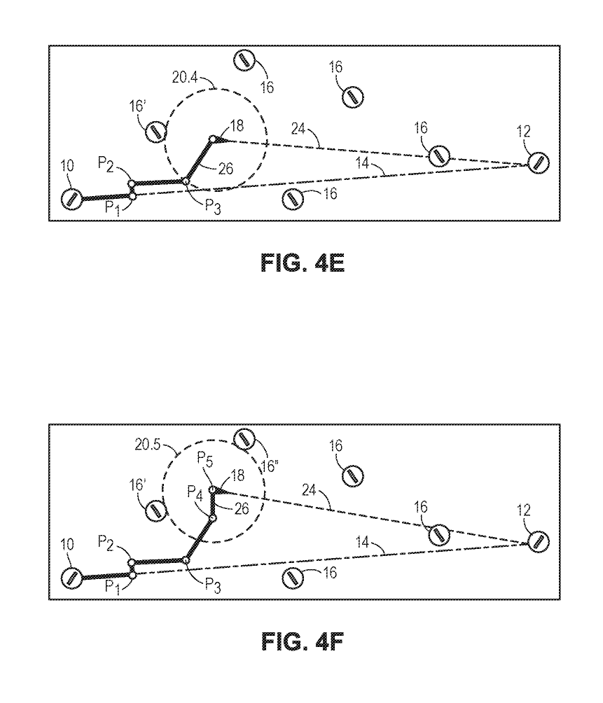

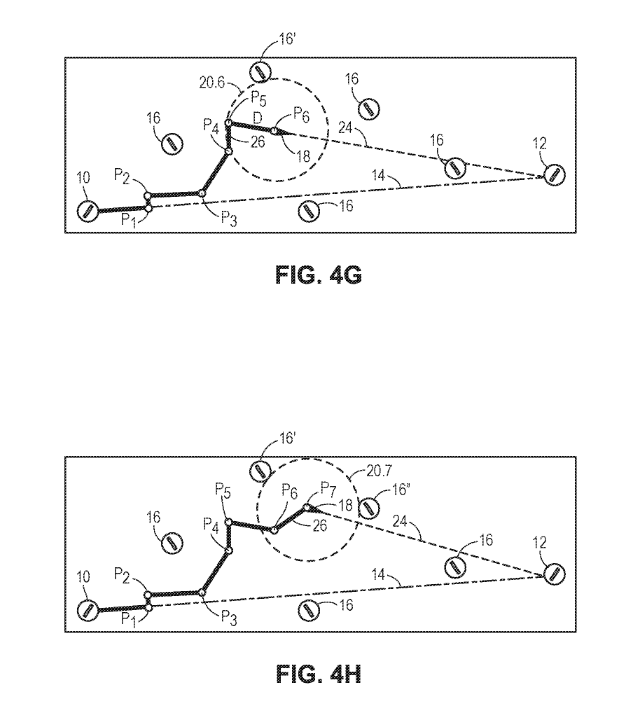

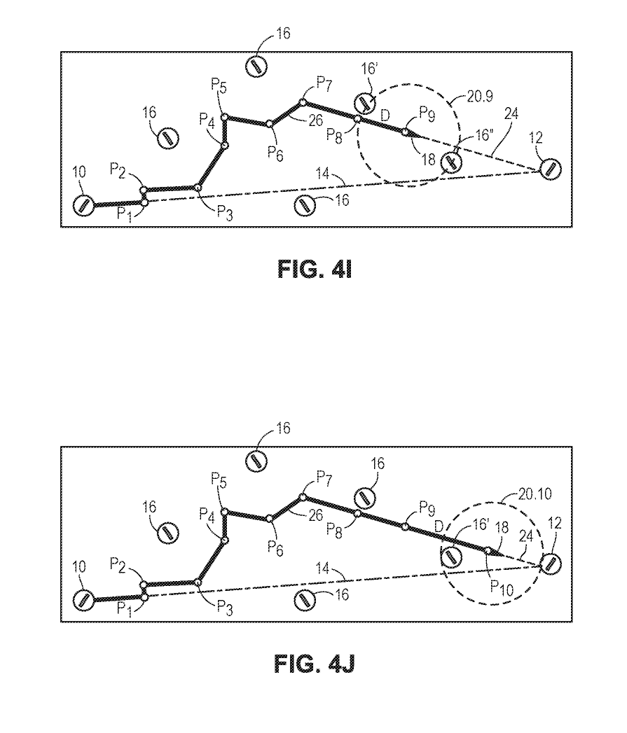

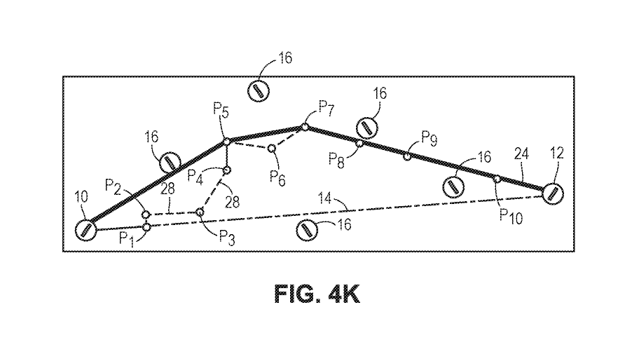

FIG. 1B is a schematic representation illustrating a calculated optimized aircraft flight path 22 in accordance with embodiments of the technology. In embodiments, when the starting location 10 or the destination location 12 is located within the glide range perimeter 20 of aircraft 18, either one can also function as an available landing location 16 when determining the optimal flight path as described below. As shown in FIG. 1B, embodiments include the optimized flight path 22 being calculated such that as the aircraft 18 travels along optimized flight path 22, an available landing location is always within gliding range of the aircraft 18, as represented by the glide range perimeters 20.1-20.5. Thus, as illustrated in FIG. 1B, embodiments include the glide range perimeters 20.1-20.5 varying throughout the determination of the optimized flight path 22, indicating changes in the glide range perimeter calculation at each segment of the optimized flight path 22. For example, the glide range perimeter 20.2 is larger than glide range perimeters 20.1 and 20.3-20.5, while glide range perimeter 20.5 is smaller than glide range perimeters 20.1-20.4. However, for ease of explanation, the glide range perimeter shown in FIGS. 4A-4K, which are used to illustrate the calculations of the optimized flight path 22 in greater detail and further discussed below, assume that the glide range perimeters 20 are equal to one another at each iterative step in the overall calculation of the optimized flight path 22.

In embodiments, the calculation of the optimal flight path 22 may be determined via the execution of a series of iterative steps that determine each glide range perimeter 20.1-20.N for a number N of segments over which the optimized flight path 22 is segmented. For example, once the available landing locations 16 are identified, embodiments include calculating a repeating series of steps including (i) advancing the aircraft a set distance in the direction of the destination location 12 to a new location (i.e., an “advancement position”) along the flight path, (ii) calculating a glide range perimeter at the new location, (iii) identifying the closest available landing location 16 from the new location, (iv) determining whether the closest available landing location 16 is within the calculated glide range perimeter, and, if so, storing the new location, and (v) if the closest available landing location 16 is not within the calculated glide range perimeter, then moving the aircraft's location back to the previous location, adjusting the flight path to place the aircraft at an adjusted location within gliding range of a second-closest available landing location 16, and storing this adjusted location. The series of steps (i) through (v) may then be repeated, advancing the aircraft 18 along the flight path, until the aircraft 18 reaches the destination location 12. In the event that there is no path where the aircraft 18 can be advanced, embodiments include a notification being presented to the user. Otherwise, each time the aircraft 18 is advanced toward the destination location 12 at a position that is within the aircraft's glide range, that location is saved as part of the optimized flight path 22. Additional details regarding the calculation of optimized flight path 22 are discussed below with reference to FIGS. 2, 3, and 4A-4K.

FIG. 2 is a block diagram illustrating an example aircraft flight path optimization system 200 in accordance with embodiments of the technology. Aircraft flight path optimization system 200 includes a computing device 202, and optionally includes one or more data sources 250. In some embodiments, computing device 202 communicates with the one or more data sources 250 to receive data from and/or send data to the one or more data sources 250. In other embodiments, computing device 202 may alternatively store any of the data stored in the one or more data sources 250 locally (e.g., in memory unit 214 or in a removable memory card, for example). Therefore, in accordance with the latter embodiments, one or more of the one or more data sources 250 are not necessary for computing device 202 to calculate an optimized flight path.

In various embodiments, computing device 202 may be implemented as any suitable computing device configured to calculate an optimized flight path, as discussed herein. In some embodiments, computing device 202 may be implemented as a mobile computing device or a component that is otherwise separate from other aircraft components. For example, computing device 202 may be implemented as a laptop computer, a tablet computer, a smartphone, etc. In other embodiments, computing device 202 may be implemented as a component that is integrated as part of, installed within, or otherwise mounted within an aircraft. For example, such embodiments may include computing device 202 being implemented as a panel-mounted avionics system, a primary or secondary in-flight display system, a line-replaceable unit (LRU), etc.

Furthermore, the one or more data sources 250 may be configured as any suitable type of storage devices such as databases, memories, hard drives, data servers, cloud-based servers, etc., depending upon whether the one or more data sources 250 are integrated as part of computing device 202 or as components that are separate from computing device 202. For example, the one or more data sources 250 may be located within an aircraft as various components with which computing device 202 is configured to communicate via link 260, and may represent any suitable number and/or type of wired and/or wireless links. To provide another example, the one or more data sources 250 may be remotely located in an area outside of the aircraft or on the ground (e.g., as one or more servers configured to provide a specific type of information). To provide yet another example, the one or more data sources 250 may be part of memory unit 214 or an external memory card from which computing device 202 may access, read, and/or write various data stored thereon.

In any event, embodiments include the one or more data sources 250 storing information that may be used in the calculation of an optimized flight path. As illustrated in FIG. 2, the one or more data sources 250 may include an aircraft information data source 250.1, a site information data source 250.2, a weather information data source 250.3, and a geographic information data source 250.4. Additional or alternate data sources may also be included as part of the one or more data sources 250, which are not shown in FIG. 2 for purposes of brevity.

The aircraft information data source 250.1 may store, for example, specific aircraft data for different types of aircraft. The aircraft data may include, for example, glide ratios, glide data, and/or maximum altitudes specified for different aircraft used to calculate the glide range perimeter. Embodiments include computing device 202 accessing the aircraft information data source 250.1 to identify information regarding the aircraft for which an optimized flight path is to be calculated. For example, a user may identify a type of aircraft via user interface 206, resulting in the computing device 202 accessing the aircraft information stored in data source 250.1 to identify information associated with that particular aircraft, which is then used to calculate an optimized flight path.

Site information data source 250.2 may contain, for example, location information for airports, airstrips, and other locations such that a starting location, a destination location, and any available landing locations may be determined. In embodiments, computing device 202 may access site information data source 250.2 to determine the geographic locations (e.g., geographic coordinates) of the aircraft's starting location (e.g., starting location 10, as shown in FIGS. 1A-1B), a destination location provided by the user starting location (e.g., destination location 12, as shown in in FIGS. 1A-1B), as well as identifying all available landing locations (e.g., available landing locations 16, as shown in FIGS. 1A-1B).

Weather information data source 250.3 and a geography information data source 250.4 may also store weather conditions and geographic conditions, respectively, which are optionally used in the calculation of an optimized flight path. For example, weather information data source 250.3 may be implemented as a weather data having specific weather data pertinent to calculating flight plans, such as wind speed, direction, pressure, temperature, etc., at various altitudes. Geography information data source 250.4 may contain, for example, geographic information such as terrain data indicating the elevation and contours associated with the ground over which an optimized flight path is calculated. The aircraft's glide range perimeter at various locations over the optimized flight path, may be calculated using any suitable combination of the aforementioned data stored in one or more data sources 250 (or alternatively, the same type of data retrieved form another location, such as memory unit 214).

In an embodiment, computing device 202 may include a processor unit 204, a user interface 206, a communication unit 208, a display 210, a location-determining component 212, and a memory unit 214. Computing device 202 may include additional, fewer, or alternative elements than those shown in FIG. 2.

Processor unit 204 may be implemented as any suitable type and/or number of processors, such as a host processor of computing device 202, for example. To provide additional examples, processor unit 204 may be implemented as an application specific integrated circuit (ASIC), an embedded processor, a central processing unit associated with computing device 202, etc. Processor unit 204 may be coupled with and/or otherwise be configured to communicate, control, operate in conjunction with, and/or affect operation of one or more of user interface 206, communication unit 208, display 210, location-determining component 212, and/or memory unit 214 via one or more wired and/or wireless interconnections, such as any suitable number of data and/or address buses, for example. Additionally or alternatively, one or more of user interface 206, communication unit 208, display 210, location-determining component 212, and/or memory unit 214 may be coupled to or otherwise configured to operate with one another in conjunction with, or independently of, processor unit 204. The interconnections used to support such interoperability amongst the various components of computing device 202 are not shown in FIG. 2 for purposes of brevity.

Processor unit 204 may be configured to retrieve, process, and/or analyze data stored in memory unit 214, to store data to memory unit 214, to replace data stored in memory unit 214, to support one or more algorithms used to calculate an initial and an optimized flight path, to facilitate user interaction with computing device 202, to handle and process user inputs provided via user interface 206, to retrieve data via one or more data sources 250 and/or memory unit 214 that are used to calculate an optimized flight path, to receive geographic location data generated by location determining component 212, to perform various processing operations, to control various functions of computing device 202, etc. Additional details associated with such functions and calculations are further discussed below.

User interface 206 may be configured to facilitate user interaction with computing device 202 and/or to provide user feedback. In an embodiment, a user may interact with user interface 206 to place computing device 202 into various modes of operation, to initiate certain functions, modify settings, set options, provide various input used to calculate an optimized flight path such as destination locations, etc. For example, user interface 206 may include a user-input device such as an interactive portion of display 210 (e.g., one or more “soft” keys, buttons, menu options, etc.) displayed on display 210, physical buttons integrated as part of computing device 202 that may have dedicated and/or multi-purpose functionality, etc. To provide another example, user interface 206 may cause visual notifications to be displayed via display 210 and/or audible notifications to be sounded. Audible notifications may be sounded via implementation of any suitable device, such as a buzzer, speaker, etc., which are not shown in FIG. 2 for purposes of brevity.

Communication unit 208 may be configured to support any suitable number and/or type of communication protocols to facilitate communications between computing device 202 and the one or more data sources 250. Communication unit 206 may be implemented with any suitable combination of hardware and/or software to facilitate such functionality. For example, communication unit 206 may be implemented with any suitable number of wired and/or wireless transceivers, ports, connectors, antennas, etc. Additionally or alternatively, communication unit 206 may be configured to support communications between computing device 202 and one or more other computing devices not shown in FIG. 2 for purposes of brevity such as external memory cards, components of an aircraft in which computing device 202 is installed, LRU's, etc. Examples of wireless communication standards that may be implemented by computing device 202 include, but are not limited to, communications according to: one or more standard of the Institute of Electrical and Electronics Engineers (IEEE), such as 802.11 or 802.16 (Wi-Max) standards; Wi-Fi standards promulgated by the Wi-Fi Alliance; ZigBee standards promulgated by the ZigBee Alliance; Bluetooth standards promulgated by the Bluetooth Special Interest Group; ANT or ANT+ standards promulgated by Dynastream Innovations, Inc.; cellular communication standards such as 3G and Long Term Evolution (LTE); Controller Area Network (CAN) serial data bus communication protocols for avionics, and so on.

Display 210 may be implemented as any suitable type of display configured to facilitate user interaction with computing device 202, such as a capacitive touch screen display, a resistive touch screen display, etc. In various aspects, display 210 may be configured to work in conjunction with user-interface 206 and/or processor unit 204 to detect user inputs upon a user selecting a displayed interactive icon or other graphic, the selection of a “soft” key, to identify user selections of various knobs, switches, buttons, and/or other objects displayed via display 210, etc.

Location-determining component 212 may receive signal data transmitted by one or more position data platforms and/or position data transmitters, such as GPS satellites. More particularly, location-determining component 212 may manage and process signal data received from GPS satellites via a GPS receiver. Location-determining component 212 may thus determine a geographic position of computing device 202 by processing the received signal data, which may include various data suitable for use in position determination, such as timing signals, ranging signals, ephemerides, almanacs, and so forth. Location-determining component 212 may be configured to continuously determine the geographic position of computing device 202 or do so in accordance with a particular recurring schedule such as several times per second, once every second, once every 5 seconds, etc. In this way, the geographic position of computing device 202 may be tracked and/or logged over time and stored in memory unit 214 as geographic location data.

Location-determining component 212 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide position/location information, timing information, speed information, and a variety of other navigation-related data. Accordingly, location-determining component 212 may be configured in a variety of ways to perform a wide variety of functions. For example, location-determining component 212 may be configured for avionics; however, location-determining component 212 may also be configured for on-foot navigation or for vehicle navigation or tracking.

Location-determining component 212, for example, can use signal data received via a GPS receiver in combination with map data that is stored in memory unit 214 to generate navigation instructions (e.g., instructions in accordance with a calculated optimized flight path to a particular destination location), show a current position on a map, and so on. Location-determining component 212 may include one or more antennas to receive signal data. Location-determining component 212 may also provide other position-determining functionality, such as to determine an average speed, calculate an arrival time, and so on.

It should be understood that a wide variety of positioning systems other than GPS may be employed, such as other satellite systems (e.g., GNSS), terrestrial based systems (e.g., wireless-phone based systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros, odometers, accelerometers and magnetometers), use of “dead reckoning” techniques, and so on. In other examples, positioning-determining functionality may be implemented through the use of predictive algorithms, utilizing previously collected positioning data for specific flight paths.

The memory unit 214 is an example of device-readable storage media that provides storage functionality to store various data associated with the operation of the computing device 202, such as software program, modules, and sub-modules discussed herein, or other data to instruct the processor unit 204 and other elements of the computing device 202 to perform the techniques described herein. Although a single memory unit 214 is shown in FIG. 2, a wide variety of types and combinations of memory may be implemented. The memory unit 214 may be integral with the processor unit 204, stand-alone memory, or a combination of both. The memory unit 214 may include, for example, removable and non-removable memory elements such as random access memory (RAM), read-only memory (ROM), Flash (e.g., secure digital (SD) card, mini-SD card, micro-SD card), solid-state disk (SSD), magnetic, optical, universal serial bus (USB) memory devices, and so forth.

Moreover, in accordance with various embodiments, memory unit 214 may be a computer-readable non-transitory storage device that may include any suitable combination of volatile (e.g., a random access memory (RAM), or non-volatile memory (e.g., battery-backed RAM, FLASH, etc.). Memory unit 214 may be configured to store instructions executable on processor unit 204. These instructions may include machine readable instructions that, when executed by processor unit 204, cause processor unit 204 to perform various acts as described herein. Memory unit 214 may also be configured to store any other suitable data used in by the computing device 202, such as geographic location data associated with a calculated optimized flight path, as discussed herein.

Flight path initialization module 216 is a region of memory unit 214 configured to store instructions, that when executed by processor unit 204, cause processor unit 204 to perform various acts in accordance with applicable embodiments as described herein. Again, a user may enter information into computing device 202 via user interface 206, which may include an airport name or other information identifying a destination location. A user may also enter additional information such as a starting location for a flight path, a type and/or model of the aircraft, anticipated wind or weather conditions, desired altitude limits, etc. Alternatively, computing device 202 may determine some of this information (e.g., the starting location) via other means, such as by referencing the current geographic location determined by location-determining component 212, to the geographic location of airports stored in memory unit 114 or information retrieved from the one or more data sources 250 via communications unit 208.

In any event, embodiments include processor unit 204 executing instructions stored in flight path initialization module 216 to calculate an initial, straight-line flight path to a specified destination. For example, with reference to FIG. 1A, the calculated initial flight path may be similar to initial straight-line flight path 14, represented as a straight line between the starting location 10 and the destination location 12. In embodiments, this initial straight-line flight path may be used as starting or reference path that is used to calculate the optimized flight path, as discussed in further detail below.

Flight path optimization module 218 is a region of memory unit 214 configured to store instructions, that when executed by processor unit 204, cause processor unit 204 to perform various acts in accordance with applicable embodiments as described herein. In an embodiment, flight path optimization module 218 includes instructions that, when executed by processor unit 204, cause processor unit 204 to utilize the information entered by a user and/or calculated by computing device 202 to calculate an optimized flight path. To do so, flight path optimization module 218 may include several other sub-modules 218A-218D, which may represent executable algorithms, code, applications, programs, etc., used to calculate a specific portion of the overall flight path optimization process using the initial straight-line flight path as an initial reference.

In an embodiment, instructions stored in flight path optimization module 218 may facilitate processor unit 204 identifying all suitable landing locations within a defined radius of the initial straight-line flight path. This may include, for example, the available landing locations 16, as shown in FIGS. 1A-1B. In an embodiment, computing device 202 may identify these locations by referencing a range of geographic locations associated with the initial straight-line flight path to geographic locations of available landing locations stored in memory unit 214 and/or accessed via the one or more data sources 250.

Once the starting location, the destination location, the initial straight-line flight path, and the available landing locations are each identified, the initial straight-line flight path may be further adjusted to calculate the optimized flight path to ensure that each of the available landing locations is within the aircraft's gliding range throughout the duration of the optimized flight path. The steps associated with this calculation are now discussed in detail with continued reference to FIGS. 4A-4K.

To calculate an optimized flight path, embodiments include computing device 202 first segmenting the initial flight path, which may be accomplished via execution of instructions stored in flight path segmentation sub-module 218A. To do so, processor unit 204 may determine a segment distance “D” (as shown in FIGS. 4A-4K) that the aircraft can be advanced along a flight path to a new advancement position which is, initially, in a direction along the initial straight-line flight path 14. For example, as shown in FIG. 4A, the position of the aircraft 18 may be advanced a segment distance D along initial straight-line flight path 14 (i.e., in the direction of destination location 12) to a new advancement position P_{N}, which in this case is P₁.

Each time the aircraft 18 is advanced by this distance D, the aircraft's glide range perimeter is calculated and a determination is made regarding whether the aircraft is within gliding range of an available landing location, as further discussed below. In some embodiments, the distance D may be set to any suitable distance depending on the desired accuracy of the optimized flight path calculation (i.e., the likelihood that the calculated flight path will guarantee that a suitable landing location is always within the aircraft's gliding range). For example, the distance D may be specified by a user or set to a predetermined distance such as one mile, 1000 feet, 500 feet, etc., requiring the optimized flight path to be calculated on a per-segment basis in accordance with this segment distance. Decreasing the segment distance D increases the number of calculation iterations required to complete the calculation of the optimized flight path, while increasing the resolution and thus the overall accuracy of the resulting calculation. Therefore, the embodiments include varying the segment distance D to recognize a tradeoff between the overall time required to calculate an optimized flight path and the accuracy of the resulting calculation.

Glide range perimeter sub-module 218B is a region of memory unit 214 configured to store instructions, that when executed by processor unit 204, cause processor unit 204 to perform various acts in accordance with applicable embodiments as described herein. In an embodiment, glide range perimeter sub-module 218B includes instructions that, when executed by processor unit 204, cause processor unit 204 to calculate the aircraft's glide range perimeter at each segment of an overall optimized flight path calculation. Again, the aircraft's glide range perimeter at any point along a calculated flight path may be a function of several variables such as the aircraft's glide ratio, the aircraft's current altitude, wind direction and speed at various altitudes, etc. Thus, in various embodiments, processor unit 204 may calculate the glide range perimeter using any suitable combination of user-provided inputs and data retrieved form one or more sources (e.g., from one or more data sources 250 or data stored in memory unit 214).

For example, processor unit 204 may execute instructions stored in glide range perimeter calculation sub-module 218B to receive input data from a user regarding the aircraft 18 via user interface 206. To provide an illustrative example, a user may input or otherwise identify the type, make, or model of the aircraft 18 via user interface 206. Upon doing so, computing device 202 may reference aircraft data stored in memory unit 214 and/or retrieve aircraft data stored in one or more data sources 250 via communication unit 208 for several different types of aircraft to calculate the specific glide range perimeter 20.1-20.N of the aircraft 18 at each segment N of the flight path being calculated, as shown in FIGS. 4A-4K. For example, the altitude for calculating the glide range perimeter may be based on a maximum permissible altitude identified in the glide data or an altitude specified by the user via user interface 206 or stored in aircraft information data source 250.1.

In various embodiments, the glide range perimeters 20.1-20.N may be calculated using any suitable techniques, such as the aforementioned known algorithms and methods. For example, the glide range perimeters may be calculated using only the glide ratio of the aircraft and the current altitude of the aircraft to define a ring around the aircraft with a radius equal to the aircraft's instantaneous altitude multiplied by the glide ratio. To provide another example, the glide range perimeters may be calculated using the glide ratio of the aircraft, the aircraft's altitude, and the aircraft's elevation above the underlying terrain (height above ground). To provide additional examples, additional factors and criteria may be incorporated to more accurately define the glide range perimeters, such as winds aloft, various weather conditions, the surrounding terrain, geographical objects, specific aircraft features and conditions, and other factors that can impede or otherwise reduce the aircraft's gliding capability. Additionally, the calculation of the glide range perimeters may include a margin factor that allows the calculated glide range perimeters to be slightly less than the actual glide range of the aircraft to account for uncertainty, pilot inefficiencies such as flying at an airspeed other than best glide speed, and/or small gaps in the calculated flight path where the aircraft may temporarily not be located in gliding range of an available landing location.

Again, any suitable information relevant to glide range perimeter calculations may be provided by a user and/or retrieved by computing device 202 as needed. For example, the glide range perimeters 20.1-20.N may change along different positions of the flight path based upon current conditions as a result of using various combinations of available data as part of this calculation. As examples, heavy winds in one direction at a certain location or altitude may reduce the aircraft's gliding distance in one direction of the glide range perimeter, or a mountain range may be present at a particular location along the flight path that reduces the allowable gliding distance on one side of the glide range perimeter. The current altitude of the aircraft also significantly affects the size of the glide range perimeter. Thus, as the aircraft's altitude increases, the total distance it can glide increases, thereby increasing the glide range perimeter 20.1-20.N at that position. As a result, the size and shape of the glide range perimeter may dynamically change along the selected flight path, and embodiments include recalculating the glide range perimeter at different segments or locations of the flight path based on anticipated conditions (e.g., weather, wind), known terrain (e.g., mountain ranges), elevation, and anticipated altitude of the aircraft.

To provide an illustrative example with reference to FIGS. 4A-4K, after advancing aircraft 18 the distance D to a new advancement position P₁ (as shown in FIG. 4A), computing device 202 calculates the glide range perimeter 20.1 for the aircraft 18 based upon the altitude of the aircraft 18 at this position and/or other factors as discussed herein. Once the glide range perimeter 20.1 is calculated for the aircraft 18 at advancement position P₁, the nearest available landing location to advancement position P₁ is identified, and it is determined whether this available landing location is located within the calculated glide range perimeter 20.1. As shown in FIG. 4A, the starting location 10 is still within the calculated glide range perimeter 20.1 after the aircraft 18 is advanced a distance D from the starting location 10 to the advancement position P₁. Therefore, embodiments include the advancement position P₁ being recorded and saved (e.g., in memory unit 214) as one point to be used in the overall calculation of the optimized flight path 22.

Once the advancement position P₁ is recorded and saved, embodiments include further advancing the aircraft 18 towards the destination location 12 by another distance D to a new advancement position P₂, as shown in FIG. 4B. Computing device 202 then calculates the glide range perimeter 20.2 of aircraft 18 at this new advancement position. Once the glide range perimeter 20.2 is calculated for aircraft 18 at advancement position P₂, the nearest available landing location to the advancement position P₂ is identified, and it is determined whether this available landing location is located within the calculated glide range perimeter 20.2.

But, as shown in FIG. 4B, no available landing locations are within the calculated glide range perimeter 20.2 after the aircraft 18 is advanced to advancement position P₂. Thus, embodiments include computing device 202 backtracking the position of the aircraft to the previous advancement position (in this case to advancement position P₁) and identifying the second-closest suitable landing location from that point such that a new, adjusted position P₂ can be identified. To do so, computing device 202 may adjust the initial straight-line flight path 14 by shifting in the direction of the second-closest landing location 16″ by a cross track distance 26, as shown in FIG. 4C. To facilitate this functionality, processor unit 204 may execute instructions stored in cross track calculation sub-module 218C to determine the length and direction of the cross track distance 26, as further discussed below. Once the aircraft is moved to the adjusted position P₂, embodiments include computing device 202 recording and storing this adjusted position P₂ as shown in FIG. 4C (instead of the advancement position P₂ as shown in FIG. 4B) as another point to be used in the overall calculation of the optimized flight path 22. In any event, after each advancement position or adjusted position P_{N} is stored, the aircraft's current position is moved to this stored position along the optimized flight path, and the calculations are then repeated by further advancing the aircraft 18 towards the destination location 12 from the previously-stored position.

For ease of explanation, as shown in FIG. 4B, a line 24 can be drawn from the aircraft's current position to destination location 12. Thus, when the aircraft 18 is located at starting location 10, line 24 is the straight-line flight path 14 between starting location 10 and destination location 12. Similarly, when aircraft 18 remains positioned on straight-line flight path 14, line 24 can be located along and identical to straight-line flight path 14. However, as illustrated in FIG. 4C, when aircraft 18 is not located on straight-line flight path 14, line 24 is drawn from the current position of aircraft 18 and represents a new separate line from straight-line flight path 14. By drawing line 24 each time aircraft 18 is advanced by the segment distance D, the calculation of optimized flight path 22 always directs the aircraft 18 towards the direction of destination location 12 when possible, thereby reducing the total distance traveled. It is also recognized that line 24, straight-line flight path 14, and cross-track distances 26, as described below) need not be technically “drawn” while performing each step; instead, these elements can be represented as an equation and/or coordinates in a coordinate system, or contained within an algorithm or series of algorithms executed by processor unit 204.

Cross track calculation sub-module 218C may include instructions allowing processor 202 to calculate the cross track distance 26 in any suitable manner. For example, as shown in FIG. 4C, the location of aircraft 18 is first backtracked along the initial straight-line flight path 14 by the distance D. From the advancement position P₁, the second-closest available landing location (denoted as 16″, the closest being the starting position 10) can then be identified. After identifying the second-closest available landing location 16″, a cross-track distance 26 may be calculated that is sufficient to place the second-closest available landing location 16″ within the aircraft's glide range perimeter 20.2 at the position P₂. In embodiments, processor unit 204 may execute instructions stored in cross track calculation sub-module 218C to calculate cross-track distance 26 angled away from the initial straight-line flight path 14 in the direction of the second-closest available landing location 16″.

In embodiments, cross-track distance 26 may be calculated by determining the distance the aircraft 18 can travel in the general direction of the second-closest available landing location 16″ from the straight-line flight path 14 to place the second-closest available landing location 16″ and the previous closest identified available landing location (the starting position 10) within glide range perimeter 20.2 at the new, adjusted position P₂, which is shifted laterally from the straight-line flight path 14 by the cross track distance 26. In other words, cross-track distance 26 may be orientated toward a midpoint between the second-closest available landing location 16″ and the previous closest identified available landing location as shown in FIGS. 4C, 4F, and 4H.

Moreover, after calculating cross-track distance 26, processor unit 204 may determine whether aircraft 18 can travel along cross-track distance 26 while at least one available landing location 16 (i.e., the closest landing location, in this case the starting location 10 or the second-closest landing location 16″) remains within glide range perimeter 20.2. Once this calculation has been completed, embodiments include processor unit 204 advancing the aircraft 18 laterally away from line 14 by the cross-track distance 26 and recording and saving this new position P₂. As shown and discussed with reference to FIGS. 4D-4J, this process of advancing the aircraft 18 a distance D, calculating the glide range perimeter 20.N, determining whether landing location is within the glide range perimeter at each position, and determining the various points along the calculated flight path within glide range, may be repeated until the aircraft 18 is advanced to a point in which the aircraft 18 is within glide range of the destination location 12.

In the event that, at one of these steps, it is determined that the aircraft 18 cannot travel along the cross-track distance 26 while ensuring that at least one available landing location 16 remains within glide range perimeter 20, then embodiments include notifying the user that no flight path is available based on the designated altitude, the locations of available landing locations 16, and/or the identified conditions affecting aircraft 18. For example, display 210 may present the user with one or more notifications, alerts, information, options, etc., to allow the user to re-input some of the initial data used to calculate the optimized flight path. For example, processor unit 204 may determine whether, for locations in which at least one available landing location cannot be calculated, the current altitude of the aircraft 18 can be increased to allow such a calculation to be made.

According to some embodiments, processor unit 204 may determine that the glide range perimeter at a new cross-track position cannot contain both the second-closest available landing location 16″ and the previous closest identified available landing location (known herein as 16′, which may include the starting position 10). In such a case, then processor unit 204 may execute instructions stored in cross track calculation sub-module 218C to exclude the selected available landing location from the determination of the second-closest available landing location 16″, and to instead identify a new second-closest available landing location 16″, until a successful cross-track distance 26 can be calculated.

Moreover, instructions stored in cross track calculation sub-module 218C may allow processor 202 to execute additional steps if a new position cannot be obtained either by advancing the aircraft 18 by a segment distance D or by moving the aircraft 18 along the cross-track distance 26. For example, processor unit 204 may backtrack the aircraft to one or more previous positions and generate a new path by excluding one or more of the selected available landing locations 16. This backtracking step may be repeated for any number of aircraft positions until an optimized flight path 22 can be computed. Additionally or alternatively, cross track calculation sub-module 218C may contain instructions to facilitate a bidirectional algorithm (such as Bidirectional A*) such that processor unit 204 can determine the correct or optimal route for optimized flight path 22.

FIGS. 4C-4J illustrate the details in repeating the calculations described above to calculate an optimized flight path 22. For example, as shown in FIG. 4C, position P₂ is recorded and stored, and the aircraft 18 is then advanced a distance D along a new line 24 drawn from the adjusted position P₂ towards the destination location 12 to a new advancement position P₃. From the advancement position P₃, a new glide range perimeter 20.3 is calculated, and it is further determined whether one of the landing locations 16 (in this case 16′) is within this glide range perimeter. Therefore, no backtracking or cross track calculations are needed from the advancement position P₃, and position P₃ is recorded and stored by computing device 202.

However, as shown in FIG. 4D, the aircraft 18, if advanced a distance D along the line 24 (not shown) could potentially be in gliding range of the landing location 16 denoted with a circle in FIG. 4E. However, embodiments include not only ensuring that a single landing location exists for the aircraft 18 over the entire flight path, but also ensuring that the multiple landing locations 16 are within gliding range whenever possible. Therefore, as shown in FIGS. 4E-4F, processor unit 204 has calculated cross track distances 26 resulting in the aircraft 18 being placed at adjusted positions P₄ and P₅. As shown in FIG. 4E, adjusted position P₅ is approximately a midpoint between the nearest available landing location 16′ and the second nearest available landing location 16″ (as shown in FIG. 4F). These calculations are repeated to place the aircraft 18 along new positions P₆-P₁₀, as shown in FIGS. 4G-4J.

In certain situations, it is possible for the aircraft's calculated glide range perimeter 20 to be within range of the previous nearest available landing location 16′ at position P_{N-1} (i.e., the backtracked position) and to be within range of the current nearest available landing location 16′ at position P_{N} (i.e., the advancement position), yet not be within range of either available landing locations 16′ for a brief distance between positions P_{N-1} and P_{N}. This can occur, for example, when the previous nearest available landing location 16′ (determined when aircraft 18 is located at position P_{N-1}) is located near the trailing edge of the glide range perimeter 20 at position P_{N-1}, the current nearest available landing location 16′ (determined when the aircraft 18 is located at position P_{N}) is located near the front edge of glide range perimeter 20 at position P_{N}, and the distance between positions P_{N-1} and P_{N} is greater than the diameter of the glide range perimeter 20. To account for these potential situations, according to certain embodiments, the segment distance D for each advancement of aircraft 18 may be reduced, as described above. In doing so, such embodiments may limit the distance of any areas between landing locations 16 where the glide range perimeter 20 is not within range of either landing location 16. Additionally or alternatively, embodiments include incorporating a safety factor into the calculation of the glide range perimeter 20 that enables the actual gliding range of aircraft 18 to be within range of an available landing location when traveling from position P_{N-1} to P_{N}.

After all the series of steps have been performed to allow the aircraft 18 to reach the destination location 12, the recorded and saved positions P₁-P₁₀ may be utilized as part of a smoothing algorithm to generate the resulting optimal flight path 22, which intersects one or more of the saved positions P₁-P₁₀ from the starting location 10 to the destination location 12. To facilitate this functionality, processor unit 204 may execute instructions stored in flight path smoothing sub-module 218D. In various embodiments, flight path smoothing sub-module 218D may include any suitable number and type of algorithms to facilitate generating a smooth, optimized flight path 22 using each of the starting location 10, the destination location 12, and the saved positions P₁-P₁₀. The optimized flight path 22, which is shown in FIG. 4K, may then be displayed or provided to the user via display 210.

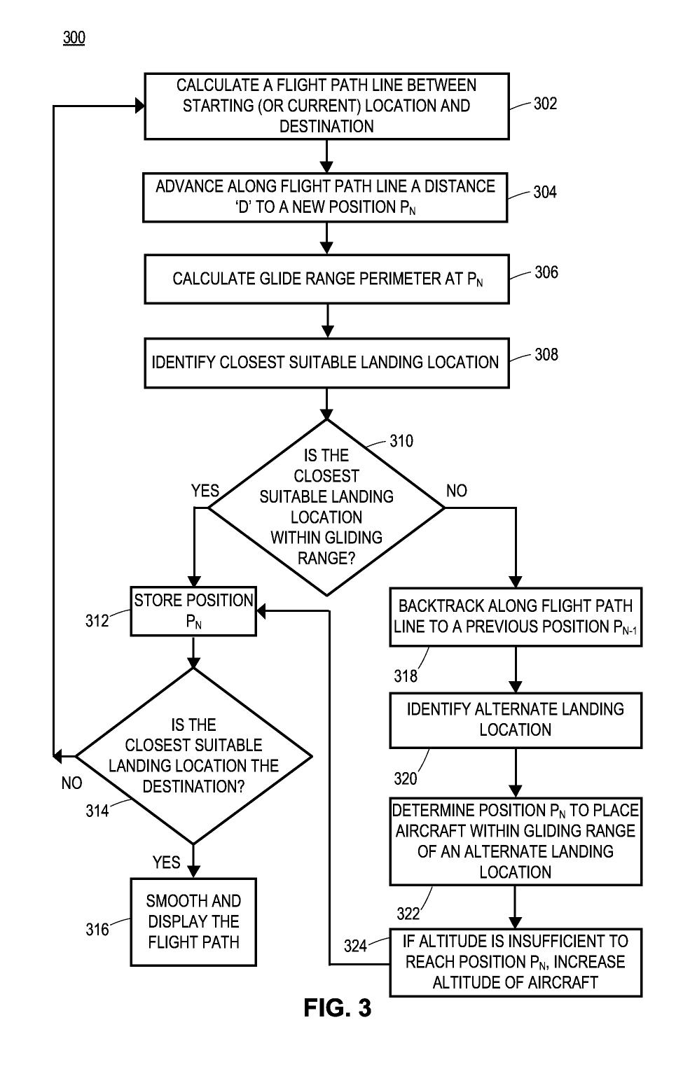

FIG. 3 is a flowchart 300 for determining an optimized aircraft flight path in accordance with embodiments of the technology. In various embodiments, one or more regions of method 300 (or the entire method 300) may be implemented by any suitable device. For example, one or more regions of method 300 may be performed by computing device 202 in conjunction with one or more data sources 250, as shown in FIG. 2. Method 300 represents the calculations performed to calculate and display an optimized flight path. For example, method 300 may represent the iterative steps taken to calculate an optimized flight path 22, as discussed herein with reference to FIGS. 1B and 4A-4K, using input received via user interface 206, data accessed from memory unit 214, and/or one more data sources 250, with the calculated optimized flight path 22 being displayed via display 210.

Method 300 may begin with one or more processors calculating a flight path line between a starting or current location and the location destination (block 302). For the first aircraft advancement iterative calculation, this flight path line may be the same as the initial straight-line flight path 14 between the aircraft's starting location 10 and the destination location 12, as discussed with reference to FIGS. 1B and 4A-4K (block 302). This may also include, for example, calculating a line 24 between a new aircraft position (i.e., an adjusted or advancement position) P_{N} in a direction towards the destination location 12, as discussed with reference to FIGS. 4C-4K (block 302).

Method 300 may include one or more processors advancing the aircraft's position a distance D along the calculated flight path line (block 302) in a direction towards the destination location to a position P_{N} (block 304). Again, this distance D may include, for example, a user-defined distance that represents a flight segment for optimized flight path calculations (block 304).

Method 300 may include one or more processors calculating the aircraft's glide range perimeter at the advancement location P_{N} (block 306). The glide range perimeter may be calculated based upon several factors such as user-provided data, aircraft information, weather information, etc., as discussed herein (block 306).

Method 300 may include one or more processors identifying the closest suitable landing location within the aircraft's gliding range based upon the previously-calculated glide range perimeter (blocks 306, 308). This may include, for example, determining the closest available landing location 16′, as discussed with reference to FIGS. 4A-4K (block 308).

Method 300 may include one or more processors determining whether the closest available landing location is within gliding range of the aircraft (block 310). For example, with reference to FIG. 4A, this may include determining whether the aircraft 18 is within gilding range of the closest available landing location 16 within the glide range perimeter 20.1. If this is the case (YES), such as in FIG. 4A, then embodiments include one or more processors recording and storing the location P_{N}, which is Pi in this example (block 312).

At this point, method 300 may include one or more processors determining whether the suitable landing location (in this case the starting location 10) is the destination (block 314). If not, which is the case in this example, then method 300 may revert back to calculating a flight path line between the current location (e.g., advancement position P₁) and the destination location to determine additional positions for the calculated optimized flight path (block 302). Continuing to use FIGS. 4A-4K as an example, method 300 may include one or more processors repeating the previous steps of advancing the aircraft along the flight path line by a distance D (block 304), calculating a glide range perimeter at the new location (block 306) (in this case to a location P₂, as shown in FIG. 4B), identifying the closest suitable landing location (block 308), and determining whether the closest suitable landing location is within gliding range (block 310). In the case of location P₂, as shown in FIG. 4B, the closest available landing location 16 is not within gliding range (NO), and therefore method 300 would include backtracking along the flight path line the distance D to the previous position P_{N-1}, in this case location P₁, as shown in FIG. 4C (block 318).

Continuing the previous example with reference to FIGS. 4A-4K, once backtracked to the position P₁, as shown in FIG. 4B, method 300 may include one or more processors identifying an alternate landing location (block 320). Using FIG. 4C as an example, this may include the second-closest suitable landing location 16″ to the position P₁ (block 320). Once the alternate (e.g., second-closest) suitable landing location 16″ is identified (block 320), method 300 may include one or more processors determining a new adjusted position P_{N}, to place the aircraft within gliding range of the alternate landing location (block 322). Continuing the previous example, the location P₂ (as shown in FIG. 4C-4K, and not FIG. 4B) places the aircraft 18 within gliding range of the alternate (e.g., second-closest) suitable landing location 16″ (block 322). This may include, for example, processor unit 204 calculating a cross track distance 26 from the current flight path line (i.e., the initial straight-line flight path 14 in this example) towards the second-closest suitable landing location 16″, as shown in FIG. 4C. This may also include, for example, processor unit 204 calculating a cross track distance that places the position P_{N} at a midpoint between the closest available landing location 16′ and the second-closest available landing location 16″ (as shown in FIGS. 4C, 4F, and 4H for positions P₂, P₅, and P₇, respectively) (block 322).

To determine an alternate landing location, method 300 may include one or more processors determining whether the aircraft's altitude is sufficient to reach the alternate (e.g., second-closest) suitable landing location 16″ (block 324). If not, then method 300 may include the one or more processors increasing the aircraft altitude along the calculated flight path until the alternate landing location is within gliding range from that particular location (block 324). Otherwise, the aircraft's altitude need not be adjusted if the aircraft's currently set altitude at that point along the flight path places the aircraft within gliding range of the alternate suitable landing location (block 324).

In any event, once the new aircraft position P_{N} is calculated, method 300 may include one or more processors recording and storing the location P_{N}, which is P₂ in this example (block 312). Method 300 may then continue in a similar fashion from a new, current location with respect to most recently-calculated position (P₂ in this example), i.e., by determining whether the suitable landing location (in this case the second-closest suitable landing location 16″) is the destination (block 314). This process may be repeated for each segment of the flight path until each position is stored (block 312). This may include, for example, iteratively calculating each position P₁₋₁₀ of the aircraft 18 throughout the entire flight path, as shown in FIGS. 4A-4J.

Thus, continuing this example, once position P₁₀ of the aircraft has been stored, the closest suitable landing location will be the destination (block 314, YES). In this case, method 300 may include one or more processors smoothing and displaying the resulting smoothed optimized flight path (block 316). For example, a smoothed, optimized flight path may be generated and displayed using each of the starting location 10, the destination location 12, and the saved positions P₁-P₁₀, as shown in and discussed with reference to FIG. 4K (block 316).

Again, in some instances it may not be possible to calculate an optimized flight path, e.g., if the aircraft cannot travel along a calculated cross-track distance while ensuring that at least one available landing location remains within the calculated glide range perimeter (block 322). For ease of explanation, method 300 is illustrated in FIG. 3 assuming that such a condition has not occurred. However, embodiments of method 300 include one or more processors determining whether a specific position P_{N} is available based on the designated altitude, the locations of available landing locations, and/or the identified conditions affecting the aircraft. In the event that a flight path or a specific position along the flight path cannot be calculated (i.e., because no suitable landing location is within gliding range at one or more positions), embodiments include one or more processors causing one or more notifications, alerts, information, options, etc., to be presented. Thus, although not shown in FIG. 3, method 300 may include allowing a user to re-input some of the initial data used to calculate the optimized flight path or to otherwise terminate if a flight path cannot be calculated.

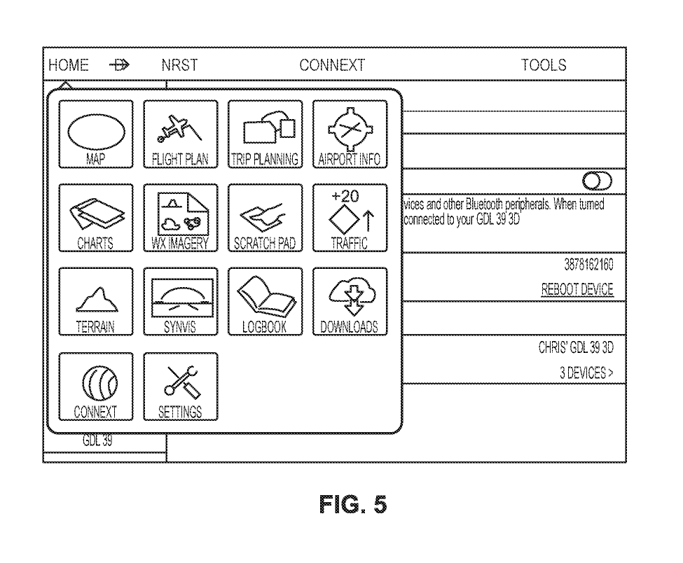

FIGS. 5-8 illustrate example screenshots of a software application that may be used in accordance with various embodiments. In embodiments, the software application described herein may be implemented via one or more components of aircraft flight path optimization system 200, as shown and discussed herein with reference to FIG. 2. For example, the software application described herein may be an example of software stored on and executed by suitable components associated with computing device 202. Thus, the software application may be used in accordance with such embodiments to allow a user to generate an optimized flight path 22 and allow a user to provide, access and/or view various information relating to the starting location 10, the destination location 12, available landing locations 16, the aircraft 18, terrain conditions, weather conditions, etc.

FIG. 5 illustrates a menu page for the application, according to one embodiment, which can allow the user to create an optimized flight path, view and/or edit an existing flight path, download a saved flight path, view and identify airport information for starting locations, destination locations, and available landing locations, and view and/or access weather and terrain data.

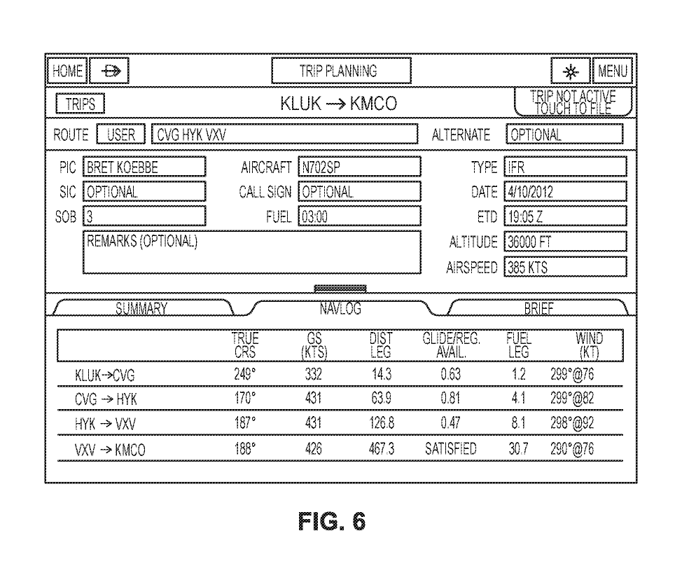

FIG. 6 illustrates a trip planning component of the software application, according to one embodiment, that can allow the user to enter information for an aircraft, view and edit altitude data for a particular flight path, view information about airports that can serve as a starting location, a destination location, or available landing locations, and view previous flight paths.

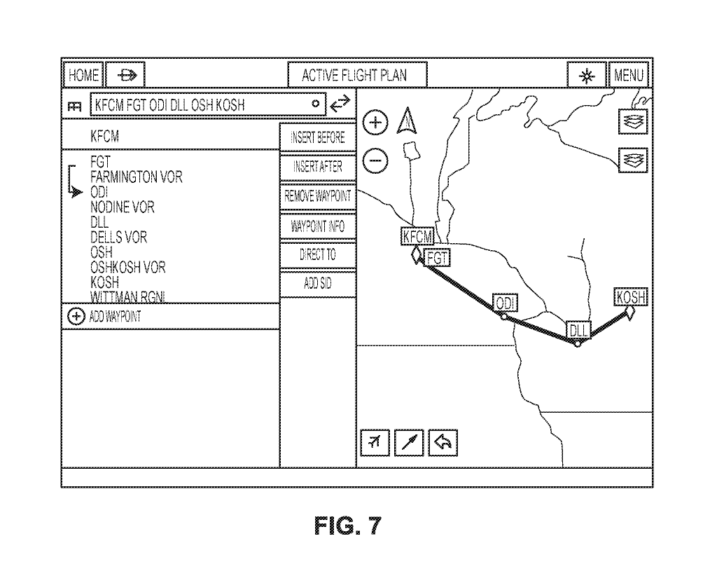

FIG. 7 illustrates a display of an active flight path through the software application with a map overlay showing the aircraft's position along the flight path and options for adding/editing waypoints and available landing locations, according to one embodiment.

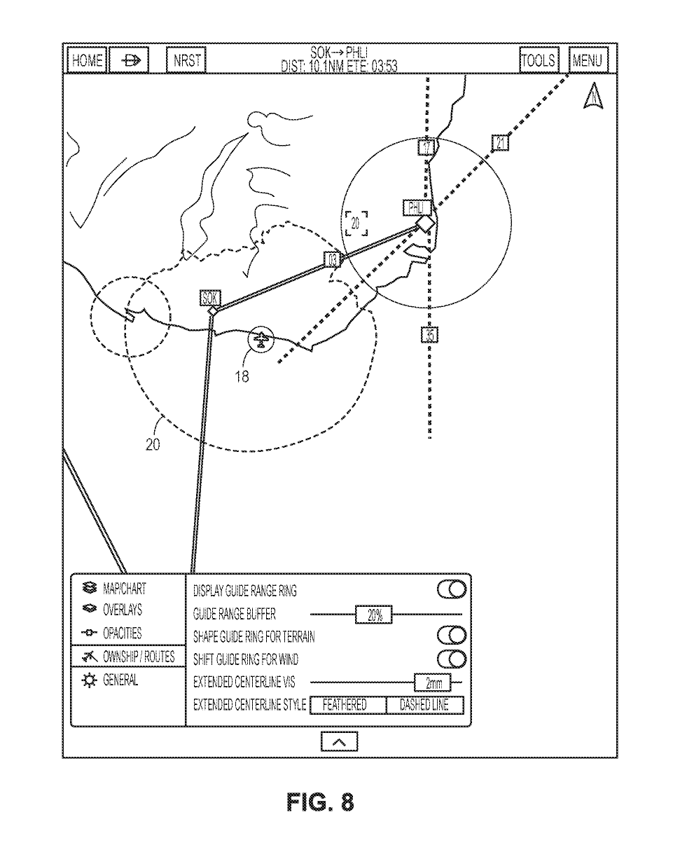

FIG. 8 illustrates a map overlay function through the application, according to one embodiment, showing an aircraft 18 and its glide range perimeter 20, which is affected by approaching terrain.

Moreover, some of the Figures described herein illustrate example block diagrams having one or more functional components. It will be understood that such block diagrams are for illustrative purposes and the devices described and shown may have additional, fewer, or alternate components than those illustrated. Additionally, in various embodiments, the components (as well as the functionality provided by the respective components) may be associated with or otherwise integrated as part of any suitable components.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

Although the foregoing text sets forth a detailed description of numerous different embodiments, it should be understood that the detailed description is to be construed as exemplary only and does not describe every possible embodiment because describing every possible embodiment would be impractical, if not impossible. In light of the foregoing text, numerous alternative embodiments may be implemented, using either current technology or technology developed after the filing date of this patent application.

Having thus described various embodiments of the technology, what is claimed as new and desired to be protected by Letters Patent includes the following:

What is claimed is:

1. A computing device, comprising:
a processor unit configured to:
identify one or more positions of the aircraft located between the aircraft's starting location and a destination location such that at least one available landing location is within gliding range of the aircraft at each of the identified one or more positions, and
calculate a flight path from the starting location to the destination location in accordance with the one or more identified positions such that the aircraft is consistently within gliding range of at least one available landing location over the entirety of the flight path; and
a display configured to present the flight path.

2. The computing device of claim 1, wherein the processor unit is configured to determine the one or more identified positions by advancing the aircraft by a segmented distance towards the destination location and determining, each time the aircraft is advanced by the segmented distance, the closest available landing location to the aircraft's position.

3. The computing device of claim 2, wherein the processor unit is configured to determine, each time the aircraft is advanced by the segmented distance, whether the closest available landing location to the aircraft's position is within gliding range.

4. The computing device of claim 3, wherein the processor unit is configured to advance the aircraft by the segmented distance towards the destination location and, when the closest available landing location to the aircraft's position is not is within gliding range, to identify the second-closest available landing location from the aircraft's position prior to being advanced by the segmented distance.

5. The computing device of claim 4, wherein the processor unit is configured to adjust the aircraft's position prior to being advanced by the segmented distance to be within gliding range of the second-closest available landing location, and to store the aircraft's adjusted position as one of the one or more identified positions.

6. The computing device of claim 1, wherein the processor unit is further configured to calculate the gliding range using one or more of (i) aircraft data for one or more types of aircraft indicative of a glide ratio, (ii) weather data containing anticipated weather conditions data, (iii) terrain data, and (iv) the aircraft's maximum altitude over the entirety of the flight path.

7. The computing device of claim 1, wherein the processor unit is further configured to calculate the gliding range at each of the one or more identified positions between the aircraft's starting location and the destination location.

8. A system, comprising:
one or more data sources configured to store terrain data, weather data, and aircraft information including maximum aircraft altitude;
a computing device configured to:
calculate a gliding range for the aircraft based upon the terrain data, the weather data, and the maximum aircraft altitude to identify one or more positions of the aircraft located between the aircraft's starting location and a destination location,
calculate a flight path from the starting location to the destination location in accordance with the one or more identified positions such that the aircraft is consistently within gliding range of at least one available landing location over the entirety of the flight path; and
display the flight path.

9. The system of claim 8, wherein the computing device is further configured to calculate the gliding range at each of the one or more identified positions between the aircraft's starting location and the destination location.

10. The system of claim 8, wherein the one or more data sources store available landing locations include shorelines and runways.

11. The system of claim 8, wherein the computing device is configured to determine the one or more identified positions by advancing the aircraft by a segmented distance and determining, each time the aircraft is advanced by the segmented distance, the closest available landing location to the aircraft's position.

12. The system of claim 11, wherein the computing device is configured to determine, each time the aircraft is advanced by the segmented distance, whether the closest available landing location to the aircraft's position is within gliding range.

13. The computing device of claim 12, wherein the computing device is configured to:
advance the aircraft by the segmented distance towards the destination location to an advancement position,
when the closest available landing location to the advancement position is not within gliding range, to identify the second-closest available landing location from the aircraft's position prior to being advanced by the segmented distance,
adjust the aircraft's position prior to being advanced by the segmented distance to an adjusted position that is different than the advancement position and is within gliding range of the second-closest available landing location, and
store the aircraft's adjusted position as one of the one or more identified positions.

14. A computing device, comprising:
a processor unit configured to:
calculate a current position for the aircraft as a position between the aircraft's starting location and a destination location, the current position initially being the aircraft's starting location;
calculate a gliding range for the aircraft at the aircraft's current position;
calculate an advancement position from the aircraft's current position that is equal to the aircraft's current position advanced by a segment distance in a direction towards the destination location;
identify a closest available landing location from among the one or more available landing locations to the aircraft's advancement position,
when the closest available landing location is within the gliding range of the aircraft at the advancement position, store the advancement position as a flight path location, and advance the aircraft's current position to the advancement position;
when the closest available landing location is not within the gliding range of the aircraft at the advancement position, identify a second-closest available landing location from among the one or more available landing locations to the aircraft's current position, adjust the aircraft's current position to be within gliding range of the second-closest available landing location, store the aircraft's adjusted position as a flight path location, and advance the aircraft's current position to the adjusted position; and
when the closest available landing location is the destination location, generate a flight path from the starting location to the destination location passing through each of the stored flight path locations; and
a display configured to present the flight path.

15. The computing device of claim 14, wherein the processor unit is configured, when the closest available landing location is not within the gliding range perimeter, to determine the aircraft's adjusted position as one in which (i) an available landing location previously identified as being located within the gliding range at the aircraft's current position, and (ii) the second-closest available landing location, are each within the gliding range at the aircraft's adjusted position.

16. The computing device of claim 14, wherein the computing device is a portable electronic device.

17. The computing device of claim 14, wherein the computing device is a panel-mount avionics system.

18. The computing device of claim 14, wherein the processor unit is configured to calculate, each time the aircraft's current position is advanced to either an advancement position or an adjusted position, the gliding range for the aircraft using the aircraft's altitude at the aircraft's current position.

19. The computing device of claim 14, wherein the processor unit is configured to calculate the gliding range for the aircraft at the aircraft's current position using one or more of (i) aircraft data for one or more types of aircraft indicative of a glide ratio, (ii) weather data containing anticipated weather conditions data, (iii) terrain data, and (iv) the aircraft's maximum altitude.

20. The computing device of claim 14, wherein the processor unit is configured to smooth the flight path to generate a smoothed flight path, and
wherein the display is further configured to present the smoothed flight path.
